(19) United States
(12) Patent Application Publication
(10) Pub. No.: US 2006/0220765 A1
(43) Pub. Date: Oct. 5, 2006

(54) Microwave band-pass filter

(75) Inventors: Johannes Muller, Hamburg (DE); Michael Hoeft, Asendorf (DE)

Correspondence Address: NIXON & VANDERHYE, PC, 901 NORTH GLEBE ROAD, 11TH FLOOR, ARLINGTON, VA, 22203, US

(73) Assignee: MATSUSHITA ELECTRIC INDUSTRIAL CO. LTD., Osaka (JP)

(21) Appl. No.: 11/389,283

(22) Filed: Mar. 27, 2006

(30) Foreign Application Priority Data
Mar. 29, 2005 (EP) 05006818.8

(51) Int. Cl. H01P 1/205

(52) U.S. Cl. 333/206

(57) ABSTRACT

The present invention relates to a microwave band-pass filter comprising a plurality of coupled resonators including at least one coaxial resonator (1). For suppression of higher order or spurious pass-bands the filter is characterised in that a central hole (9) extends from the upper end of the inner conductor (6) of said at least one coaxial resonator through at least part of the length of the inner conductor, the central hole (9) forming a wave guide section, the cut-off frequency of which being above the pass-band of the band-pass filter, and in that the wave guide section contains in an upper portion (11) thereof a low loss dielectric material with a dielectric constant sufficiently high so that the cut-off frequency of the wave guide section is below the first higher order response of the band-pass filter, and in that the lower end portion (10) of the central hole (9) contains a lossy material.

The present invention relates to a microwave band-pass filter comprising a plurality of coupled resonators including at least one coaxial resonator.

The microwave region of the electromagnetic spectrum finds widespread use in various fields of technology. Exemplary applications include wireless communication systems, such as mobile communication and satellite communication systems, as well as navigation and radar technology. The growing number of microwave applications increases the possibility of interference occurring within a system or between different systems. Therefore, the microwave region is divided into a plurality of distinct frequency bands. To ensure, that a particular device only communicates within the frequency band assigned to this device, microwave filters are utilized to perform band-pass and band reject functions during transmission and/or reception. Accordingly, the filters are used to separate the different frequency bands and to discriminate between wanted and unwanted signal frequencies so that the quality of the received and of the transmitted signals is largely governed by the characteristics of the filters. Commonly, the filters have to provide for a small bandwidth and a high filter quality.

For example, in communications networks based on cellular technology, such as the widely used GSM system, the coverage area is divided into a plurality of distinct cells. Each cell is assigned to a base station which comprises a transceiver that has to communicate simultaneously with a plurality of mobile devices located within its cell. This communication has to be handled with minimal interference. Therefore, the frequency range utilized for the communications signals associated with the cells are divided into a plurality of distinct frequency bands by the use of microwave filters. Due to the usually small size of the cells and the large number of mobile devices potentially located within a single cell at a time, the width of a particular band is chosen to be as small as possible. Moreover, the filters must have a high attenuation outside their pass-band and a low pass-band insertion loss in order to satisfy efficiency requirements and to preserve system sensitivity. Thus, such communication systems require an extremely high frequency selectivity in both the base stations and the mobile devices which often approaches the theoretical limit.

Commonly, microwave filters include a plurality of resonant sections which are coupled together in various configurations. Each resonant section constitutes a distinct resonator and usually comprises a space contained within a closed or substantially closed conducting surface. Upon suitable external excitation, an oscillating electromagnetic field may be maintained within this space. The resonant sections exhibit marked resonance effects and are characterized by the respective resonant frequency and band-width. In order for the filter to yield the desired filter characteristics, it is essential that the distinct resonators coupled together to form the filter have a predetermined resonant frequency and band width or pass-band. The pass-band is usually defined as the frequency range between the frequencies at which a 3 dB attenuation compared to the central resonant frequency is observed.

A general problem of band-pass filters is that they have many unwanted (or “spurious”) pass-bands. They occur due to the fact that the resonators have higher order resonances which are also named (Eigen-)modes of the corresponding structure. Accordingly, there are periodic higher order pass-bands at higher frequencies. For many applications such higher order pass-bands are not acceptable.

One solution to overcome the problem is the utilization of an additional low-pass filter. This is the most commonly applied technique which, however, is accompanied by additional costs and additional space required for the low-pass filter, as well as by an increased insertion loss.

Furthermore, there are techniques to disperse or to damp the spurious responses of the band-pass filter, as for example described in “A capacitively coupled wave guide filter with wide stop-band”, 33rd European Microwave Conference 2003, Munich, Germany, pages 1239-1242. The dispersion of the spurious responses may for example be done by using different resonant structures for each single resonator of the band-pass. Therefore, higher order eigenmodes occur at different frequencies and the spurious band-pass transmissions of the filter will be reduced.

Another possibility is to add waveguides outside of the resonator cavities which have a cut-off frequency above the pass-band of the filter and which have placed at their end absorbers of lossy material. Such a technique is described in “Wave guide band-pass filters with attenuation of higher order pass-bands”, 32rd European Microwave Conference 1993, Madrid, Spain, pages 606-607 by W. Menzel et al. for a rectangular wave guide band-pass. In between the resonators of the filter there are placed smaller rectangular waveguides having a cut-off frequency above the pass-band of the filter. In this arrangement, only fields with frequencies above the cut-off frequency of the smaller waveguides can penetrate the smaller waveguides, and are thereby damped by the lossy material at the end of the added waveguides. A disadvantage of this arrangement is the extra space needed for the added smaller waveguides which are placed in between adjacent resonators of the filter.

It is an object of the present invention to provide a microwave filter comprising a plurality of resonators including at least one coaxial resonator which allows for a sufficient suppression of spurious or higher order pass-bands without needing space for extra components.

This object is achieved by a microwave filter as defined in claim 1. Preferred embodiments of the microwave filter are set out in the dependent claims.

The microwave filter has a plurality of coupled resonators including at least one coaxial resonator. Coaxial resonators have a cylindrical inner conductor which is mounted on the base of the resonator cavity and which extends to a predetermined height, leaving a gap between its upper end and the inner surface of the top cover of the cavity. Such coaxial resonators are also referred to as combline resonators. According to the present invention, the inner conductor of the at least one coaxial resonator is provided with a central hole extending from the top end of the inner conductor over at least part of its height. This central hole forms a waveguide section which has a cut-off frequency above the pass-band of the filter. This is so because the transverse or cross-sectional dimension of the central hole of the inner conductor is smaller than the inner diameter of the coaxial resonator cavity. The waveguide section is further adapted, as will be explained below, to have a cut-off frequency below the first higher order resonance of the filter.

The lower portion of the central hole contains a lossy material which may be a lossy dielectric material, e.g. silicon carbide ceramics, or a lossy magnetic material, e.g. a resin matrix material filled with magnetic material.

With this arrangement electromagnetic fields with frequencies above the cut-off frequency of the waveguide section, which is below the first higher order or spurious pass-band frequency of the filter, will enter the central hole of the inner conductor and will be damped or attenuated by the lossy material at the bottom of the central hole. On the other hand, for frequencies within the pass-band the lossy material at its bottom is “invisible”, since these electromagnetic fields cannot enter the central hole but are decaying exponentially. Thus, the central hole with its lossy material does not affect the transmission performance of the filter within the pass-band.

A combline resonator has a height of lower than λ/4—typically λ/8—where λ is the wavelength corresponding to the center of the pass-band. The short (electrical connection between inner conductor and base plate) at the bottom of the resonator is transformed to an inductance at the top of the resonator, which together with the capacitive gap at the top of the resonator create the fundamental resonance. If only transversal electromagnetic (TEM-)waves are considered, the first higher order or spurious pass-band would be in a frequency area approximately 3 to 5 times larger than the fundamental pass-band frequency. Besides the TEM-waves, also the transversal electric (TE-) and transversal magnetic (TM-)modes of the resonator have to be considered—which in contrast to the TEM-modes have a strong dependency on the resonator diameters. Therefore, the spurious pass-band might even lie closer to the intended pass-band. To keep the TE- and TM-modes at higher frequencies, the outer diameter of the resonator should be kept small—typically much smaller than λ/2 of the fundamental pass-band frequency. The ratio of the outer diameter of the resonator to the outer diameter of the inner conductor should lie around 3.6 to guarantee a high quality factor of the resonator, since at this ratio the damping constant of the corresponding coaxial line is minimal.

The central hole needs to be adapted in order to be able to have a cut-off frequency below the first higher -order pass-band. The cut-off frequency ν_{cut} of the central hole corresponds to a wavelength λ_{cut}=2.61 r₀, where r₀ is the radius of the air-filled central hole. At frequencies larger than ν_{cut}, the first mode, i.e. the TM₀₁-mode will be able to propagate. If the frequency is further increased, other modes have to be taken into account as well. This ν_{cut}, if the central hole were filled with air as the resonator cavity, would generally correspond to a frequency many times higher than the resonance frequency in the pass-band. Since on the other hand, as mentioned above, the first higher order pass-band may already occur at 3 times of the pass-band frequency, it is necessary to lower the cut-off frequency of the central hole. This can be done by disposing a low loss dielectric material in an upper portion of the central hole, such as for example a ceramic material, which has a relative dielectric constant sufficiently high so that the cut-off frequency of the central hole can be brought to lower frequencies closer to the pass-band frequency so that already the first higher order resonance of the filter is above the cut-off frequency of the central hole. The cut-off frequency depends on properties of the material in the waveguide section as (εᵣ μᵣ)^{-1/2} (εᵣ being the relative dielectric constant and μᵣ being the relative permeability of the material). Thus, using a material with εᵣ being about 100, μᵣ being of the order of 1, would lower the cut-off frequency of the central hole by a factor 1/10 compared to an air filled waveguide section.

A dielectric material is further characterized by a dissipation factor D or a loss tangent tan δ which are identical.

This is the quantity representative for the energy loss characteristic of the material. Materials which have a value of tan δ of above 0.1 are characterized as lossy materials. On the other hand, dielectric materials with tan δ below 0.01 are considered to be low loss dielectric materials. They are electrical insulators. Dielectric properties of these materials show relatively little variation with the frequency over the microwave range. It is preferred that the low-loss dielectric materials have a loss tangent below 0.001.

The property of the central hole to have a cut-off frequency above the pass-band is defined herein in the usual manner to mean that the cut-off frequency is above the 3 dB corner frequency of the pass-band of the filter.

It will be appreciated that with the design of the present invention higher order pass-bands of the filter may be suppressed without needing any extra space or additional components. Therefore, such filter design allows to provide very efficient and compact microwave filters.

The invention will in the following be described in connection with the embodiments shown in the drawings, in which

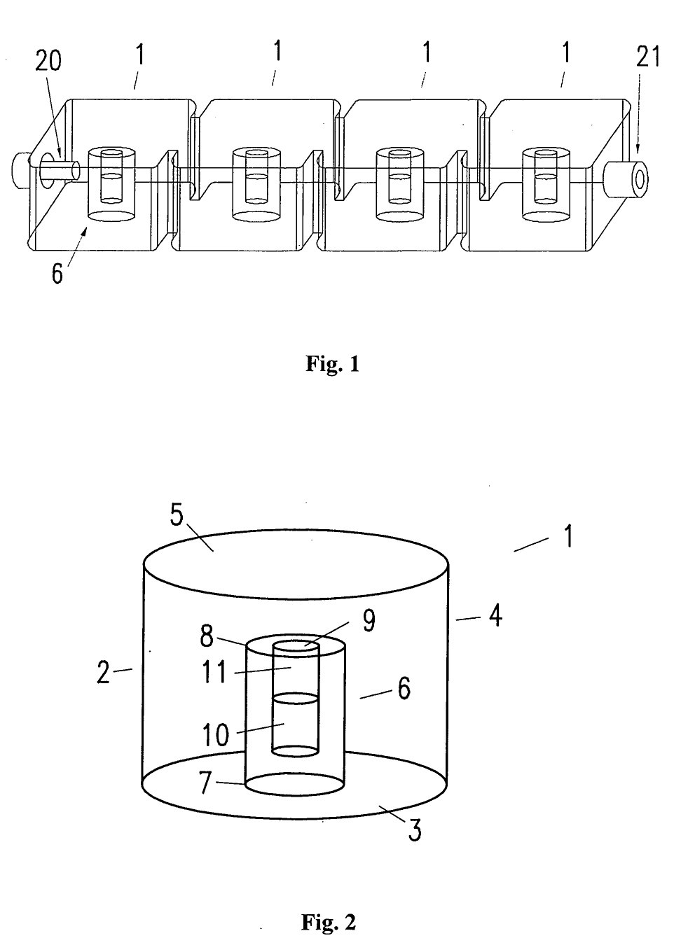

FIG. 1 is a schematical perspective representation of a four pole band-pass filter;

FIG. 2 is a perspective schematical representation of a coaxial resonator as used in the filter according to the invention; and

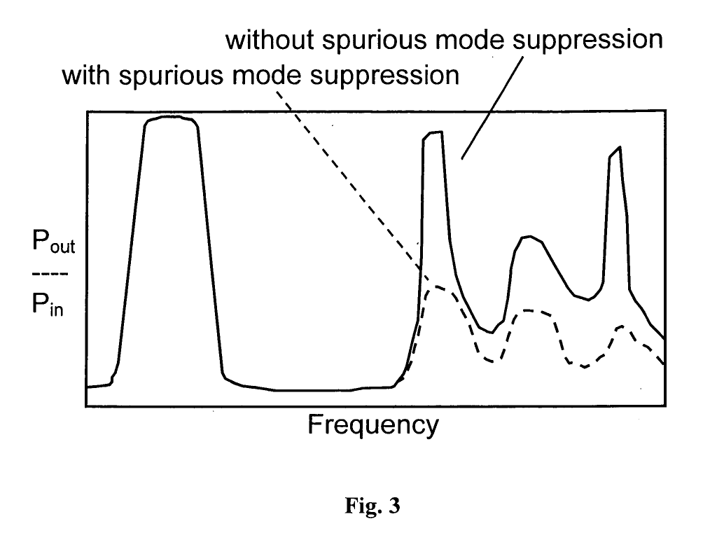

FIG. 3 shows the frequency dependent response of the filter in terms of the ratio of outgoing to incoming power with and without spurious mode suppression.

FIG. 1 shows a microwave filter comprising four coaxial resonators 1 being coupled in series. This filter has a capacitive input coupling 20 and a capacitive output coupling 21. Tuning screws for tuning frequencies and couplings are not shown. In general, there will be more than a series of resonators but rather a two-dimensional arrangement of coupled resonators.

FIG. 2 shows an individual coaxial resonator which is to be used in a filter comprising a plurality of coupled resonators according to the invention. This coaxial resonator 1 comprises a hollow cylindrical housing 2. The housing 2 is formed by a disc-shaped base 3, a side-wall 4 extending upwardly from the base 3, and a disc-shaped cover 5 secured to the upper end of the side-wall 4. The resonator 1 further includes a cylindrical inner conductor 6 which is centrally located inside the interior of the housing 2 and which is attached with its lower end 7 to the base 3. The inner conductor 6 extends upwardly from the base 3 along the longitudinal axis of the cylindrical housing 2. Its length is lower than the height of the housing 2 so that a capacitive gap is formed between the upper end 8 of the inner conductor 6 and the cover 5 of the housing 2.

The inner conductor 2 is provided with a central hole 9 which is extending from its upper end 8 into the inner conductor 6 over a part of the length of the latter. The central hole 9 may for example be drilled into the inner conductor 6.

The lower part 10 of the central hole 9 contains a lossy material which acts as an absorber. Such lossy material may for example be lossy magnetic materials such as magnetically loaded epoxide resins, as the absorber materials provided by Emerson & Cuming Microwave Products, Randolph, Mass., USA, under the tradename Eccosorb MF. The material Eccosorb MF190 for example has at 3 GHz a dielectric constant εᵣ of 28 and a magnetic permeability μᵣ of 4.5, and loss tangents of tan δ_{d} of 0.04 and tan δₘ0.09. Alternatively, lossy dielectric materials may be used, such as silicon carbide ceramics which are formed by sintering silicon carbide (SiC) powders. Such silicon carbide ceramics have dielectric constants εᵣ of typically 30 to 35, and loss tangents tan δ_{d} in the range 0.3 to 0.5.

The lossy material may partially or completely fill the lower end portion of the central hole 9.

The upper part 11 of the central hole 9 contains preferably a low-loss dielectric material (for example a ceramic material as used for dielectric resonators). As has been explained above, this upper low-loss dielectric material is needed to provide a relative dielectric constant εᵣ within the upper part of the central hole 9 which is sufficiently high to lower the cut-off frequency of the central hole 9 in order to ensure that the first higher order pass-band of the filter is above the cut-off frequency of the central hole 9. Examples for materials which are suitable as low-loss dielectric materials in the upper part of the central hole 9 are listed in table 1 below.

TABLE 1
Low loss Ceramic Materials

| | | | | Temperature |
|---|---|---|---|---|
| Material | | | Loss Tangent | Coefficent |
| Composition | εᵣ | Q * f (f in GHz) | at 4 GHz | ppm/° C. |
| BaTi₄O₉ | 38 | 40,000 | 0.0001 | +4 |
| Ba₂Ti₉O₂₀ | 40 | 40,000 | 0.0001 | +2 |
| (Zr—Sn)TiO₄ | 38 | 40,000 | 0.0001 | −4 to +10 |
| Ba(Zn_{1/3}Nb_{2/3})O₂—Ba(Zn_{1/3}Ta_{2/3})O₂ | 30 | 100,000 | 0.00004 | 0 to +10 |
| BaO—PbO—Nd₂O₃—TiO₂ | 90 | 5,000 | 0.0002 at 1 GHz | +10 to −10 |
| MgTiO₃—CaTiO₃ | 21 | 55,000 | 0.00007 | +10 to −10 |

The transition between the low-loss dielectric material in the upper portion 10 and the lossy material in the lower portion of the central hole could be a discontinuous transition, as shown in the schematic drawings, or preferably be a smooth transition. The latter may be accomplished for example by giving the lossy dielectric material in the lower portion 10 an upper surface which is inclined with respect to the longitudinal axis of the central hole 9, and by giving the low-loss dielectric material a lower surface which is complementary to the upper surface of the lossy dielectric material. This smooth transition is preferred in order to suppress reflections on the transition between the two dielectric materials. Alternatively, a smooth transition may be provided if the low-loss dielectric material and the lossy material are formed in sintering processes in which the powders of the respective materials are mixed in the transition region.

The central hole 9 serves as a cylindrical waveguide. The size (diameter) and its low-loss dielectric filling in the upper portion 11 have to be chosen such that the cut-off frequency is above the pass-band of the filter but below the first higher order or spurious pass-band of the filter. In this manner, the central hole is not “visible” for frequencies within the pass-band, and thus does not affect the filter performance in the pass-band. To guarantee that the quality factor of the resonators remains high, the dielectric material in the upper portion 11 should show a low losses as possible.

For frequencies above the cut-off frequency of the central hole, this central hole 9 is able to propagate waves. For such frequencies, the central hole 9 will be able to propagate waves, and the ground of the central hole 9 with its lossy material will be “visible” for electric fields with such frequencies. Since the cut-off frequency of the central hole 9 is adapted to be below the first higher order of spurious pass-band of the filter, all higher order or spurious modes of the filter will be attenuated or suppressed. In this way the stop-band characteristic of the filter is improved.

This is shown in FIG. 3 in which the filter performance (ratio of outgoing power to incoming power) is shown for a filter in solid lines which does not employ a higher pass-band suppression according to the present invention. This filter response shows the first pass-band and at higher frequencies undesired higher order or spurious pass-bands. By providing the coaxial resonators with inner conductors with central holes in accordance with the invention the higher order pass-bands are attenuated as shown by the dashed line in FIG. 3.

1. Microwave band-pass filter comprising a plurality of coupled resonators including at least one coaxial resonator (1), characterised in that a central hole (9) extends from the upper end of the inner conductor (6) of said at least one coaxial resonator through at least part of the length of the inner conductor, the central hole (9) forming a wave guide section, the cut-off frequency of which being above the pass-band of the band-pass filter, and in that the wave guide section contains in an upper portion (11) thereof a low loss dielectric material with a dielectric constant sufficiently high so that the cut-off frequency of the wave guide section is below the first higher order response of the band-pass filter, and in that the lower end portion (10) of the central hole (9) contains a lossy material.

2. Band-pass filter according to claim 1, characterised in that the lossy material at the lower end portion (10) of the central hole (9) is a lossy dielectric material or a lossy magnetic material.

3. Band-pass filter according to claim 1, characterised in that the low-loss dielectric material has a loss tangent tan δ below 0.001.

4. Band-pass filter according to claim 2, characterised in that the lossy material is a lossy dielectric in the form of a silicon carbide (SiC) ceramic.

5. Band-pass filter according to claim 1, characterised in that the central hole has a cylindrical shape.

6. Band-pass filter according to claim 1, characterised in that the transition between the low loss material and the lossy material in the central hole (9) is gradual in axial direction of the central hole.

7. Band-pass filter according to claim 6, characterised in that the lossy material has an upper surface which is obliquely oriented with respect to the longitudinal axis of the central hole, and the low loss dielectric material has a complementary lower surface.

8. Band-pass filter according to claim 6, characterised in that the lossy material and the low-loss dielectric material are made of sintered powder materials, and in that the respective powder materials are mixed in the transition region.
